(19) United States
(12) Patent Application Publication
(10) Pub. No.: US 2006/0246001 A1
(43) Pub. Date: Nov. 2, 2006

(54) Method for producing hydrogen

(76) Inventor: Norbert Auner, FRANKFURT AM MAIN (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/538,603

(22) PCT Filed: Dec. 11, 2003
(86) PCT No.: PCT/DE03/04086

§ 371 Date: Jun. 9, 2005

(30) Foreign Application Priority Data
Dec. 11, 2002 (DE) 102 58 072.3

(51) Int. Cl. C01B 3/02

(52) U.S. Cl. 423/648.1

(57) ABSTRACT

The invention relates to a method for producing hydrogen by reacting amorphous silicon with water, an alcohol or a carboxylic acid. Said method can be carried out independently of carbon sources and water sources and performed in situ without any hydrogen transport or storage problems.

The present invention is directed to a method for producing hydrogen.

Hydrogen is conventionally produced from hydrocarbons, i.e. from hydrocarbons containing energy carriers coal, mineral oil, natural gas. Furthermore, it is known to obtain electrolytically produced hydrogen from water. However, this method is very energy consuming (about 5 kWh/m³H₂) Moreover, water is available to a great extent only in certain regions of the world (not in desert regions). If one takes into account the diffusion behaviour of hydrogen, its storage and its transport are very dangerous since explosive mixtures (oxyhydrogen gas) are generated upon a mixing with air. A hydrogen liquefaction for storage purposes is connected with a high energy expense.

Hydrogen is considered as energy source of the future since with the generation of energy from hydrogen (combustion with oxygen for the generation of water) no gases (CO, CO₂, SO₂ etc.) which are detrimental for the environment are generated. However, on the other side the conventional production of hydrogen from hydrocarbons results in the generation of substances (CO, CO₂ etc.) which are detrimental for the environment and which are just to be avoided when energy is generated from hydrogen. Accordingly, in the last analysis this way for the production of hydrogen is no solution for the growing environmental problems and moreover results in an enforced exploitation of the coal/gas/oil reserves. In the last analysis, the problem of environmental pollution is only shifted from the place of energy generation to the place of hydrogen generation by this conventional production of hydrogen.

Accordingly, a method for producing hydrogen is desirable which can be carried out in situ and not from C sources.

It is the object of the invention to provide a method for the production of hydrogen which can be carried out independently of C sources.

The invention shows three ways to achieve this object. According to a first way of solution a method for producing hydrogen by the reaction of amorphous silicon with water is provided.

Amorphous silicon serves as starting substance for the inventive method. The production of amorphous silicon is known and is moreover proposed with new methods in the German patent applications 102 17 140.8, 102 17 124.6 and 102 17 126.2. In the last analysis, silicon dioxide serves as starting substance for the production of amorphous silicon. Silicon dioxide is available as natural resource to a great extent in the world (especially also in desert regions) so that armorphous silicon is a safe source for the production of hydrogen with which the hydrogen can be produced in situ, i.e. independently of C sources and/or water sources, without transport and storage problems.

Solids are designated as amorphous if their molecular components are not arranged in cristal lattices but irregularly. Amorphous silicon (a-Si) can be produced in a substantially less expensive manner than cristalline silicon.

It is expressly emphasized that the limits between amorphous and microcristalline or finest cristalline silicon cannot be exactly fixed. Accordingly, the invention includes that the inventive production of hydrogen can be also carried out with microcristalline or finest cristalline silicon. Appropriate limits have to be empirically ascertained.

In the above-cited older German patent application 102 17 140.8 it is mentioned that on the one side pure amorphous silicon having a black colour and not being “surface covered” and having an especially high reactivity and on the other side amorphous silicon resulting as brown powder and being “surface covered”, for instance with Cl, silyl chloride, O₂ or HO, are existing. With “surface covered” a chemical covering is meant.

On principle, the inventive method can be carried out with both kinds of amorphous silicon wherein the black amorphous silicon which is not chemically covered generally has a better reactivity than the chemically covered brown (yellow) amorphous silicon.

Accordingly, it is preferred to use black chemically uncovered amorphous silicon for the inventive method.

The inventive method can be preferably carried out at ambient temperature if a corresponding reactivity of the amorphous silicon is present which is especially the case with the black chemically uncovered amorphous silicon.

When using brown chemically covered amorphous silicon the reactivity of the silicon is dependent on the covering. So, the reactivity (reaction temperature) of the amorphous silicon can be controlled by control of the chemical covering. Experiments had the result that amorphous brown silicon covered with NH₃ has a better reactivity than amorphous brown silicon covered with O₂.

As mentioned above, under certain circumstances the inventive method can be carried out with microcristalline or finest cristalline silicon as powder either wherein this substance has a still lower reactivity than the above-mentioned brown amorphous silicon.

In the reaction of the amorphous silicon with water for the production of hydrogen (hydrolysis of Siₐₘ) in addition to hydrogen silicon dioxide (SiO₂) is generated which can be exploited or recycled.

According to the second way for carrying out the inventive method hydrogen is produced by the reaction of amorphous silicon with an alcohol. Preferably, such alcohols (ROH) are used in which R means Me (methyl) or Et (ethyl). The reaction of Siₐₘ with alcohols results in tetraalkoxy silanes (Si(OR)₄) wherein R generally means an organic radical, preferably alkyl radical. These tetraalkoxy silanes which are also designated as silica esters, are conventionally produced by the reaction of silicon halides with alcohols. With the inventive method the direct production from silicon results so that one method step is saved. There are a plurality of kinds of application for the tetraalkoxy silanes so that these compounds have a great importance as byproducts resulting from the inventive method.

According to the third way of the inventive method hydrogen is produced by the reaction of amorphous silicon with a carboxylic acid. Preferably, acetic acid (CH₃COOH) is used wherein in the reaction of Siam with acetic acid solid silicon tetraacetate is generated which has great importance as basic substance for establishing organo silanes and siloxanes/silicones.

Preferably, it is moreover provided according to the invention that the compounds Si(OR)₄, wherein R is an organic radical, especially alkyl radical or carboxylic acid radical, generated during the hydrogen production with an alcohol or a carboxylid acid are converted into SiO₂+HOR by hydrolysis. In this manner the alcohol or the carboxylic acid (acetic acid) can be recovered if the compound Si(OR)₄, especially Si(OAc)₄, is no more needed.

The H₂ equimolarly produced in this manner can be used in mobile systems (fuel cell) and stationary systems. As regards the use in fuel cells, up to now the required hydrogen was produced from CH₃OH or CH₄ in converters upstream of the fuel cell wherein in any case CO₂ was produced. In contrast, the inventive method is CO₂-free and valuable products result which are practically non-toxic and can be recycled if the demand is met.

As already mentioned above, with the brown amorphous silicon any temperatures for the reaction for the production of hydrogen can be adjusted by deactivation of the Si surface (chemical covering).

In the following the reaction process of the inventive method is shown for methyl alcohol, ethyl alcohol on the one side and for acetic acid on the other side.
R=methyl, ethyl
am=amorphous
bl=black
Ac=acetate

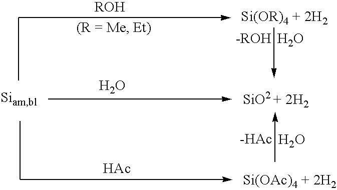

1. A method for producing hydrogen by reacting amorphous silicon with water.

2. A method for producing hydrogen by reacting amorphous silicon with an alcohol.

3. A method for producing hydrogen by reacting amorphous silicon with a carboxylic acid.

4. The method according to claim 1, characterized in that black chemically uncovered amorphous silicon is used.

5. The method according to claim 1, characterized in that it is carried out at ambient temperature.

6. The method according to claim 1, characterized in that brown chemically covered amorphous silicon is used.

7. The method according to claim 6, characterized in that the reactivity (reaction temperature) of the amorphous silicon is controlled by control of the chemical covering of the same.

8. The method according to claim 2, characterized in that the compounds Si(OR)₄, wherein R means an organic radical, especially alkyl radical or carboxylic acid radical, generate( during the hydrogen production with an alcohol or with a carboxylic acid are converted into SiO₂+HOR by hydrolysis.
